(19) United States
(12) Patent Application Publication
(10) Pub. No.: US 2022/0196180 A2
(43) Pub. Date: Jun. 23, 2022

(54) Electromagnetic Valve

(71) Applicant: NIDEC TOSOK CORPORATION, Kanagawa (JP)

(72) Inventors: Tomohiko NAKANISHI, Kanagawa (JP); Dongming CHEN, Kanagawa (JP); Satoshi YABUSHITA, Kanagawa (JP)

(73) Assignee: NIDEC TOSOK CORPORATION, Kanagawa (JP)

(21) Appl. No.: 17/022,111

(22) Filed: Sep. 16, 2020

(30) Foreign Application Priority Data
Sep. 26, 2019 (JP) 2019-175744

(51) Int. Cl. F16K 31/06; F16K 1/36

(52) U.S. Cl. CPC F16K 31/0682; F16K 31/0655; F16K 1/36

(57) ABSTRACT

An electromagnetic valve includes a solenoid having a plunger; a flow path member including a fluid passage flow path having a first flow path, a second flow path, and a relay flow path which is disposed between the first flow path and the second flow path and which connects the first flow path and the second flow path, and a cylindrical space; a valve body movably disposed in the cylindrical space; and a spring which is disposed concentrically with the valve body on an outer peripheral side of the valve body in the cylindrical space and urges the valve body.

### CROSS-REFERENCE TO RELATED APPLICATIONS

The present invention claims priority under 35 U.S.C. § 119 to Japanese Application No. 2019-175744 filed on Sep. 26, 2019 the entire content of which is incorporated herein by reference.

### BACKGROUND

### Field of the Invention

The disclosure relates to an electromagnetic valve.

### Background

An electromagnetic PCV valve mounted on a vehicle including an internal combustion engine such as an engine is known. The conventional electromagnetic PCV valve is a valve that switches between passage and blockage of blow-by gas. The conventional electromagnetic PCV valve includes a housing having a flow path through which blow-by gas may pass, a valve body which is movably supported along the axial direction and which opens and closes the middle of the flow path, a spring for urging and moving the valve body toward one side in the axial direction, and a step motor for moving the valve body toward the other side in the axial direction against the urging force of the spring.

However, in the conventional electromagnetic PCV valve, since the spring is disposed in the flow path, for example, there is a problem that impurities (deposit) contained in the blow-by gas or ice produced by freezing of water vapor in the flow path depending on the use environment of the vehicle adheres to it, which hinders the accurate operation, that is, the operation of urging the valve body without excess or deficiency.

### SUMMARY

An exemplary embodiment of an electromagnetic valve of the disclosure includes: a solenoid including a bobbin in a cylindrical shape having a through hole which penetrates along an axial direction, a plunger inserted into the through hole and supported movably along the axial direction, and a coil wound around an outer periphery of the bobbin and generating a magnetic force when energized to move the plunger in the axial direction; a flow path member connected to the solenoid and including a fluid passage flow path having a first flow path, a second flow path, and a relay flow path which is disposed between the first flow path and the second flow path and which connects the first flow path and the second flow path, and a cylindrical space disposed on the solenoid side in the axial direction when viewed from the first flow path and having a wall which faces the solenoid on one side in the axial direction; a valve body in a columnar shape disposed in the cylindrical space and movable along the axial direction together with the plunger, the valve body including a valve part which opens and closes the relay flow path on the one side in the axial direction, and a guide part which contacts the plunger on the other side in the axial direction and is guided on an inner wall surface of the cylindrical space when moving together with the plunger; and a spring which is disposed concentrically with the valve body on an outer peripheral side of the valve body in the cylindrical space, contacts the wall of the cylindrical space on the one side in the axial direction, contacts the guide part on the other side in the axial direction, and urges the valve body along the axial direction.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a view showing an example of a use state of an electromagnetic valve (open state) of the disclosure.

FIG. 2 is a view showing an example of a use state of an electromagnetic valve (closed state) of the disclosure.

FIG. 3 is a sectional view showing an exemplary embodiment of an electromagnetic valve of the disclosure.

FIG. 4 is an enlarged view of the region [A] circled by a one-dot chain line in FIG. 3.

FIG. 5 is a sectional view taken along the line B-B in FIG. 3.

### DETAILED DESCRIPTION

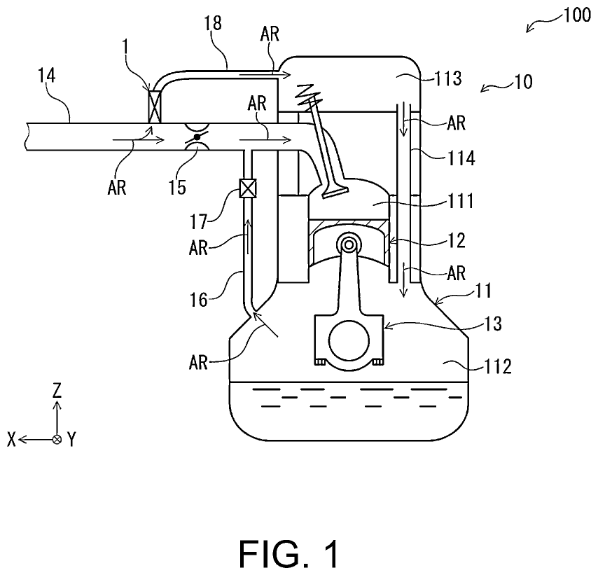

Hereinafter, exemplary embodiments of an electromagnetic valve according to the disclosure will be described with reference to FIGS. 1 to 5. Further, hereinafter, for convenience of description, three axes orthogonal to each other are set as an X axis, a Y axis, and a Z axis. For example, an XY plane including the X axis and the Y axis is horizontal, and the Z axis is vertical. A direction parallel to the X axis is referred to as “the axial direction (the axis O1 direction),” and a radial direction with this axis as the center is simply referred to as “the radial direction,” and a peripheral direction with the axis as the center is simply referred to as “the peripheral direction.” Further, the positive side in the X axis direction may be referred to as “the one side in the axial direction” or simply as “the one side,” and the negative side in the X axis direction may be referred to as “the other side in the axial direction” or simply as “the other side.” In the specification, the vertical direction, the horizontal direction, the upper side and the lower side are simply names for describing the relative positional relationship of each part, and the actual dispositional relationship and the like may be a dispositional relationship and the like other than the dispositional relationship and the like indicated by these names.

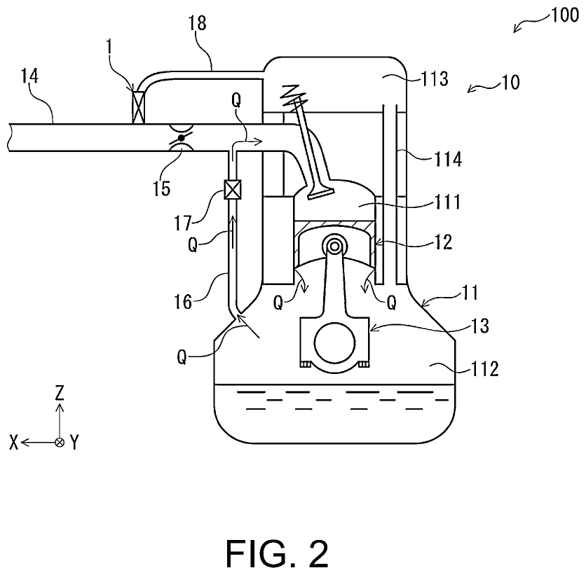

As shown in FIGS. 1 and 2, for example, an electromagnetic valve 1 is used by being mounted on a vehicle 100 including an internal combustion engine 10 such as an engine. The internal combustion engine 10 includes a housing 11 having a combustion chamber 111, a crank chamber 112 and a buffer chamber 113; a piston 12 movably provided in the combustion chamber 111; and a crank 13 provided in the crank chamber 112 for converting the back-and-forth movement of the piston 12 into a rotation movement.

Further, in the housing 11, the crank chamber 112 and the buffer chamber 113 are connected via an internal flow path 114.

An external flow path 14 is connected to the combustion chamber 111 from the outside of the housing 11. An electromagnetic valve 15, which is a throttle valve, is disposed in the middle of the external flow path 14.

The downstream side of the electromagnetic valve 15 in the external flow path 14 and the crank chamber 112 are connected via a first auxiliary flow path 16. An electromagnetic valve 17, which is a PCV valve, is disposed in the middle of the first auxiliary flow path 16.

The upstream side of the electromagnetic valve 15 in the external flow path 14 and the buffer chamber 113 are connected via a second auxiliary flow path 18. The electromagnetic valve 1 of the disclosure is disposed in the second auxiliary flow path 18 at a boundary part with the external flow path 14. The electromagnetic valve 1 is a valve that switches between opening and closing of the external flow path 14. The electromagnetic valve 1 puts the external flow path 14 in an open state (see FIG. 1) at the time of normal traveling of the vehicle 100, and puts the external flow path 14 in a closed state (see FIG. 2) at the time of leak detection of detecting a leakage of an air-fuel mixture AR (hereinafter simply referred to as “leakage”).

As shown in FIG. 1, in the open state, the air-fuel mixture AR passes through the external flow path 14, flows into the combustion chamber 111, and is used for combustion. In this way, the piston 12 may move. In addition, a part of the air-fuel mixture AR passing through the external flow path 14 flows into the second auxiliary flow path 18 from the middle of the external flow path 14, passes sequentially through the buffer chamber 113 and the internal flow path 114, and then enters the crank chamber 112. The air-fuel mixture AR that has flowed into the crank chamber 112 may return to the external flow path 14 via the first auxiliary flow path 16.

As shown in FIG. 2, in the closed state, the supply of the air-fuel mixture AR to the internal combustion engine 10 is stopped. Then, when the pressure in the combustion chamber 111 becomes high due to combustion, a portion of blow-by gas Q in the combustion chamber 111 flows over the piston 12 into the crank chamber 112. After that, the blow-by gas Q in the crank chamber 112 flows into the external flow path 14 through the first auxiliary flow path 16. At this time, if no leakage occurs, the pressure in the crank chamber 112 will decrease with time. When the pressure in the crank chamber 112 is below a threshold value, it is determined that no leakage has occurred. On the other hand, if a leakage has occurred, the pressure in the crank chamber 112 does not decrease and does not fall below the threshold value, or the pressure decrease tendency becomes slow, and it takes time to fall below the threshold value. In this case, it is determined that a leakage has occurred.

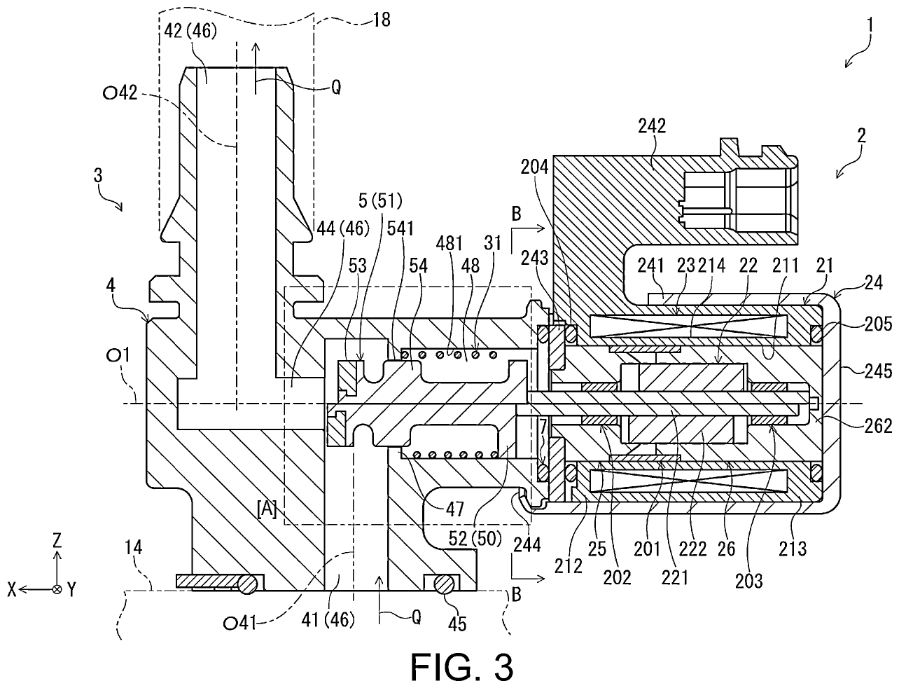

As shown in FIG. 3, the electromagnetic valve 1 includes a solenoid 2 disposed on the negative side in the X axis direction and a valve mechanism 3 disposed on the positive side in the X axis direction. Hereinafter, a configuration of each part will be described.

The solenoid 2 has a bobbin 21, a plunger 22, a coil 23, a case 24, a core 25, and a yoke 26.

The bobbin 21 is a member in a cylindrical or substantially cylindrical shape having a through hole 211. The through hole 211 penetrates along the axis O1 direction parallel to the X axis direction. Further, the inner diameter of the through hole 211 is constant along the axis O1 direction. The bobbin 21 has a flange 212 that protrudes in the radial direction on one side, and a flange 213 that protrudes in the radial direction on the other side. The bobbin 21 is made of, for example, various resin materials such as a polyester resin and a polyimide resin.

A coil 23 having conductivity is wound around an outer periphery 214 of the bobbin 21. When the coil 23 is energized, that is, with energization of the coil 23, a magnetic circuit is provided by the bobbin 21, the core 25, and the yoke 26, and a magnetic force may be generated. In this way, the plunger 22 may be moved along the axis O1 direction.

The core 25 and the yoke 26 are inserted into the through hole 211 of the bobbin 21, and the plunger 22 is inserted further to the inner side.

The core 25 is disposed on the one side in the axis O1 direction, and the yoke 26 is disposed on the other side in the axis O1 direction.

The core 25 has a circular cylindrical or substantially circular cylindrical shape as a whole, and is disposed parallel to the X axis direction. Further, the yoke 26 also has a circular cylindrical or substantially circular cylindrical shape as a whole, and is disposed parallel to the X axis direction. The core 25 and the yoke 26 are made of a soft magnetic material such as iron, that is, made of a soft magnetic metal material. In this way, a magnetic circuit that may sufficiently move the plunger 22 may be generated.

Further, the solenoid 2 has a connecting member 201 for connecting the core 25 and the yoke 26 in the through hole 211 while keeping the core 25 and the yoke 26 apart. The connecting member 201 has a circular cylindrical or substantially circular cylindrical shape, and the other end of the core 25 and the one end of the yoke 26 are fitted inside the connecting member 201. The connecting member 201 is made of a nonmagnetic and rust-resistant metal material such as austenitic stainless steel.

The plunger 22 is disposed to cross the core 25 and the yoke 26 and is supported to be movable alternately between the one side and the other side along the axis O1 direction, that is, to be movable back and forth.

The plunger 22 has a plunger body 222 in a circular cylindrical or substantially circular cylindrical shape and a plunger pin 221 inserted into the plunger body 222. The plunger pin 221 protrudes on both of the one side and the other side in the axis O1 direction. Further, the other side of the yoke 26 is closed by a wall part 262, and the movement limit of the plunger 22 to the other side is restricted by the plunger pin 221 coming into contact with the wall part 262, that is, colliding with the wall part 262.

Further, in the plunger 22, the plunger pin 221 is supported by a bush 202 in the core 25, and the plunger pin 221 is supported by a bush 203 in the yoke 26. In this way, the plunger 22 may move back and forth smoothly.

The case 24 houses the bobbin 21, the plunger 22, the coil 23, the core 25, and the yoke 26. The case 24 has a case body 241, a connector member 242, and a ring member 243.

The case body 241 has a circular cylindrical or substantially circular cylindrical shape with a bottom. That is, the case body 241 is a member in a cylindrical or substantially cylindrical shape having an opening 244 that opens on the one side in the axis O1 direction and a wall 245 that closes the other side. The yoke 26 contacts the wall 245 from the one side.

The ring member 243 has a circular ring or substantially circular ring shape and is disposed concentrically with the core 25 on the outer side of the core 25 in the radial direction. The ring member 243 contacts the core 25 from the one side.

Like the core 25, the case body 241 and the ring member 243 are made of a a soft magnetic metal material such as iron.

The connector member 242 is connected to a connector (not shown) that energizes the coil 23. The connector member 242 is made of, for example, a resin material, like the bobbin 21.

Further, the solenoid 2 includes in the case 24 a gasket 204 disposed between the ring member 243 and the flange 212 of the bobbin 21, and a gasket 205 disposed between the wall 245 of the case body 241 and the flange 213 of the bobbin 21.

The gasket 204 has a ring or substantially ring shape and is disposed concentrically with the core 25 on the outer peripheral side of the core 25. The gasket 204 is in a compressed state between the ring member 243 and the flange 212 of the bobbin 21, whereby the space between the ring member 243 and the flange 212 may be sealed.

The gasket 205 has a ring or substantially ring shape and is disposed concentrically with the yoke 26 on the outer side of the yoke 26 in the radial direction. The gasket 205 is in a compressed state between the wall 245 of the case body 241 and the flange 213 of the bobbin 21, whereby the space between the wall 245 and the flange 213 may be sealed.

In addition, the gaskets 204 and 205 are made of an elastic material. The elastic material is not particularly limited, and examples thereof include various rubber materials such as urethane rubber and silicone rubber.

The valve mechanism 3 includes a flow path member 4, a valve body 5, a spring 31, and a gasket 7.

The flow path member 4 is a member that is connected to the solenoid 2, and includes therein a fluid passage flow path 46 through which the blow-by gas Q that is a fluid may pass, and a cylindrical space 48 adjacent to the fluid passage flow path 46 via a wall 47. Further, the flow path member 4 is made of, for example, a resin material, like the bobbin 21.

The fluid passage flow path 46 has a first flow path 41, a second flow path 42, and a relay flow path 44 that connects the first flow path 41 and the second flow path 42.

The first flow path 41 is provided along the Z axis direction and opens toward the negative side in the Z axis direction. Further, the first flow path 41 side is connected to, for example, a pipe that defines the external flow path 14 to which the electromagnetic valve 1 is fixed, and is connected to the combustion chamber 111 via the external flow path 14. In addition, a gasket 45 is fitted from the outside for sealing the space between the flow path member 4 and the pipe that defines the external flow path 14.

The second flow path 42 is also provided along the Z axis direction and opens toward the positive side in the Z axis direction. In addition, a central axis 042 of the second flow path 42 is located on the positive side in the X axis direction with respect to a central axis 041 of the first flow path 41. Further, the second flow path 42 is connected to, for example, a pipe that defines the second auxiliary flow path 18.

The relay flow path 44 is provided between the first flow path 41 and the second flow path 42 along the X axis direction, that is, along the axis O1 direction. The relay flow path 44 connects the first flow path 41 and the second flow path 42. For example, in the case where the internal combustion engine 10 equipped with the electromagnetic valve 1 is a naturally aspirated engine, as shown in FIG. 3, the blow-by gas Q flows from the first flow path 41 to the second flow path 42 via the relay flow path 44.

The cylindrical space 48 is disposed on the solenoid 2 side when viewed from the first flow path 41 in the axis O1 direction. That is, the cylindrical space 48 is disposed adjacent to the first flow path 41 (fluid passage flow path 46) on the negative side in the X axis direction. The cylindrical space 48 has the wall 47 facing the solenoid 2 on the one side in the axis O1 direction. As a result, the cylindrical space 48 is separated from the fluid passage flow path 46 by the wall 47. Further, the cylindrical space 48 is provided along the X axis direction, that is, along the axis O1 direction. As a result, the cylindrical space 48 is disposed on the axis O1 together with the relay flow path 44.

Further, the gasket 7 is disposed on the negative side in the X axis direction of the cylindrical space 48. The gasket 7 has a ring or substantially ring shape and is provided concentrically with the cylindrical space 48. The gasket 7 is in a compressed state between the flow path member 4 and the ring member 243, whereby the space between the flow path member 4 and the ring member 243 may be sealed. In addition, the gasket 7, like the gasket 204, is made of an elastic material such as urethane rubber.

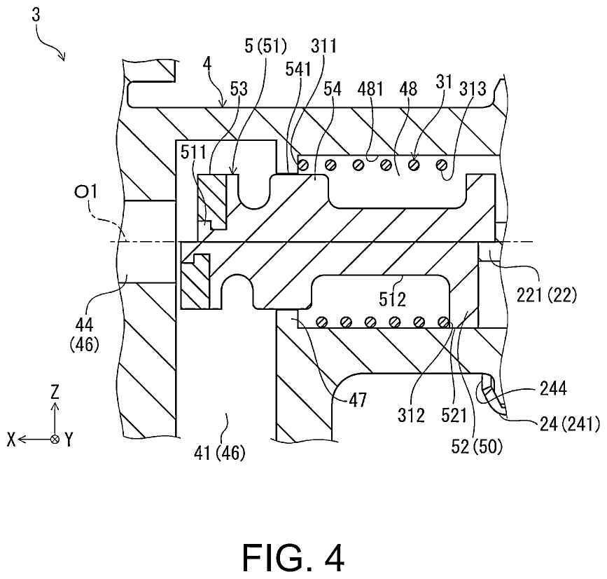

As shown in FIGS. 3 and 4, the flow path member 4 is provided with the valve body 5 that is movable along the axis O1 direction together with the plunger 22 through the wall 47. The valve body 5 has a body 51 in a columnar or substantially columnar shape and a valve part 53 in a ring or substantially ring shape.

The body 51 is disposed parallel to the X axis direction. The body 51 is provided with a protrusion 511 that protrudes toward the positive side in the X axis direction and is inserted into the valve part 53 in a ring or substantially ring shape. In this way, the protrusion 511 is fitted into the valve part 53, whereby the valve part 53 may be fixed to the body 51.

The valve part 53 may open and close the relay flow path 44 on the positive side in the X axis direction (the one side in the axis O1 direction) when the valve body 5 moves along the axis O1 direction. Further, in FIGS. 3 and 4, the valve body 5 is shown divided into an upper half part above the axis O1 and a lower half part below the axis O1. In the upper half part, the valve part 53 is separated from the relay flow path 44, and the relay flow path 44 is in the open state. In the open state, the blow-by gas Q may pass through. In the lower half part, the valve part 53 is in contact with the relay flow path 44, and the relay flow path 44 is in the closed state. In the closed state, the blow-by gas Q is blocked. In addition, the valve part 53, like the gasket 204, is made of an elastic material such as urethane rubber.

The body 51 has a guide part 50 on the negative side in the X axis direction, and an enlarged diameter part 54 between the guide part 50 and the valve part 53. Further, the body 51 may be made of a metal material such as aluminum.

The guide part 50 contacts the plunger 22 on the negative side in the X axis direction (the other side in the axis O1 direction). In this way, the valve body 5 may receive a pressing force from the plunger 22 toward the positive side in the X axis direction when the plunger 22 moves to the positive side in the X axis direction, whereby the valve body 5 may move to the positive side in the X axis direction together with the plunger 22. Then, the valve body 5 may put the relay flow path 44 in the closed state.

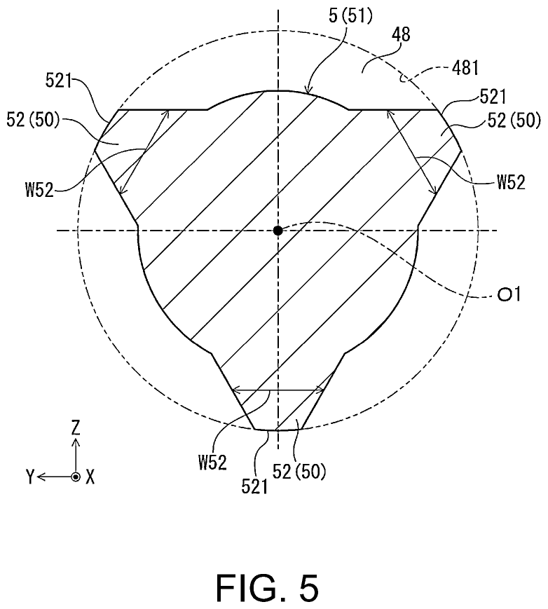

The guide part 50 is guided on an inner wall surface 481 of the cylindrical space 48 when the valve body 5 moves together with the plunger 22. In this way, the valve body 5 may move stably. In addition, the guide part 50 has a plurality of protrusions 52 provided to protrude from an outer periphery 512 of the body 51 toward the outer side in the radial direction. As shown in FIG. 5, in the exemplary embodiment, three protrusions 52 are provided at equal intervals along the peripheral direction of the body 51, but the number of protrusions 52 disposed is not limited to three. For example, the number may be two or four or more.

A top 521, which is located on the outermost side of each protrusion 52 in the radial direction, is guided in contact with the inner wall surface 481 of the cylindrical space 48 when the valve body 5 moves. In this way, the sliding resistance of the valve body 5 with the inner wall surface 481 may be suppressed as much as possible. As a result, the valve body 5 may slide stably; that is, the sliding property of the valve body 5 is improved. Further, even if the blow-by gas Q contains impurities, since the area of the tops 521 of the protrusions 52 is small, the impurities may be suppressed or prevented from adhering to the tops 521. In this way, it is possible to prevent the movement of the valve body 5 from being hindered by impurities, and thus the sliding property of the valve body 5 is further improved. Further, the cross-sectional shape of the cylindrical space 48 is a circular or substantially circular shape. The top 521 of each protrusion 52 has an arc or substantially arc shape with the same curvature as the circular or substantially circular shape of the cylindrical space 48. In this way, the valve body 5 may slide smoothly.

As shown in FIG. 5, in each protrusion 52, a width W52 of the body 51 along the peripheral direction gradually decreases (that is, tapers) toward the outer side in the radial direction. In this way, the sliding area of each protrusion 52 with respect to the inner wall surface 481 of the cylindrical space 48 may be suppressed as much as possible while maintaining the strength of each protrusion 52 when the valve body 5 moves.

When the valve body 5 moves along the axis O1 direction, a portion of the outer periphery 512 of the body 51 slides on the wall 47. In this way, the airtightness in the cylindrical space 48 may be maintained regardless of the movement of the valve body 5. Further, the wall 47 has a function as a guide wall that guides the body 51 when the valve body 5 moves along the axis O1 direction.

Further, the enlarged diameter part 54 which has an enlarged outer diameter and is in a ring or substantially ring shape is provided at a portion of the body 51 that slides on the wall 47. In this way, rigidity may be increased by the enlarged diameter part 54, whereby damage or deformation may be reliably prevented from occurring during movement of the valve body 5. In addition, the enlarged diameter part 54 in a ring or substantially ring shape contacts the wall 47 over the entire periphery in the peripheral direction.

As described above, the three protrusions 52 are provided at equal intervals along the peripheral direction of the valve body 5. Further, each protrusion 52 and the enlarged diameter part 54 are provided separate from each other in the X axis direction. In this way, the posture of the valve body 5 in the cylindrical space 48 may be maintained, whereby the valve body 5 may move stably in the cylindrical space 48.

The spring 31 is disposed in the cylindrical space 48. The spring 31 is a coil spring and is disposed concentrically with the valve body 5 on the outer peripheral side of the valve body 5. Further, as shown in FIG. 4, the spring 31 has one end 311 in contact with the wall 47 on the positive side in the X axis direction (the one side in the axis O1 direction) and has the other end 312 in contact with the guide part 50 on the negative side in the X axis direction (the other side in the axis O1 direction). In this way, the spring 31 is in a compressed state between the wall 47 and the guide part 50, whereby the valve body 5 may be urged to the negative side in the X axis direction. Then, the urging force of the spring 31 may move the valve body 5 together with the plunger 22 to the negative side in the X axis direction. In this way, the valve body 5 may be separated from the relay flow path 44 to put the relay flow path 44 in the open state.

In addition, to put the relay flow path 44 in the closed state, the solenoid 2 moves the plunger 22 together with the valve body 5 to positive side in the X axis direction against the urging force of the spring 31.

Further, the spring 31 is a coil spring, and particularly preferably a compression coil spring. In this way, the structure of the spring 31 is simplified.

Further, an outer periphery 541 of the enlarged diameter part 54 of the valve body 5 is in contact with an inner periphery 313 of the spring 31, which is a coil spring. In this way, the spring 31 is prevented from buckling in the cylindrical space 48, whereby the spring 31 may expand and contract stably.

As described above, the fluid passing through the fluid passage flow path 46 is the blow-by gas Q. The blow-by gas Q may contain impurities (deposit). Further, depending on the use environment of the vehicle 100, the water vapor in the fluid passage flow path 46 may be frozen to produce ice. When impurities, ice or the like adheres to the spring 31, the accurate operation of the spring 31 (that is, the operation of urging the valve body 5 without excess or deficiency) is hindered, and the opening and closing operation of the valve body 5 with respect to the relay flow path 44 becomes difficult. As a result, normal traveling of the vehicle 100 and leakage detection may not be performed accurately.

In the electromagnetic valve 1, the spring 31 that urges the valve body 5 is disposed in the cylindrical space 48 that is isolated from the fluid passage flow path 46. This prevents impurities, ice, or the like from adhering to the spring 31, and thus the spring 31 operates accurately; that is, the spring 31 may urge the valve body 5 without excess or deficiency. Then, the opening and closing operation by the valve body 5 is accurately performed, and as a result, the normal traveling of the vehicle 100 and the leakage detection are reliably performed.

Further, by disposing the spring 31 in the cylindrical space 48, the spring 31 is prevented from hindering the passage of the blow-by gas Q. In this way, the flow rate of the blow-by gas Q may be sufficiently secured.

Although the electromagnetic valve of the disclosure has been described above with the exemplary embodiments of the drawings, the disclosure is not limited thereto. Each part which configures the electromagnetic valve may be replaced with any configuration which may exhibit the same function. Moreover, any component may be added.

Further, although the electromagnetic valve 1 is used by being mounted on the vehicle 100 including the internal combustion engine 10 such as an engine in the above exemplary embodiments, the applicable place of the electromagnetic valve is not limited to the vehicle 100. Further, the fluid whose passage and blockage are switched by the electromagnetic valve 1 is not limited to gas (blow-by gas Q) but may be a liquid or a mixture of gas and liquid.

Further, in the above exemplary embodiments, the electromagnetic valve 1 is configured so that the blow-by gas Q flows from the first flow path 41 toward the second flow path 42, but the blow-by gas Q may flow from the second flow path 42 toward the first flow path 41 depending on the use state of the electromagnetic valve 1.

Further, the enlarged diameter part 54 of the valve body 5 is not limited to a ring or substantially ring shape. In the case where the enlarged diameter part 54 is in a ring or substantially ring shape, the enlarged diameter part 54 contacts the wall 47 at one place over the entire periphery in the peripheral direction thereof. In addition, for example, the enlarged diameter part 54 may have a plurality of protrusions disposed along the peripheral direction, and each protrusion may be configured to contact the wall 47. In this case, the enlarged diameter part 54 is in contact with the wall 47 at a number of places the same as the number of protrusions disposed, that is, at a plurality of places. Further, the number of protrusions disposed is not particularly limited, but is preferably three or more, for example.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. An electromagnetic valve, comprising:
a solenoid comprising:
a bobbin in a cylindrical shape having a through hole which penetrates along an axial direction;
a plunger inserted into the through hole and supported movably along the axial direction; and
a coil wound around an outer periphery of the bobbin and generating a magnetic force when energized to move the plunger in the axial direction;
a flow path member connected to the solenoid and comprising:
a fluid passage flow path having a first flow path, a second flow path, and a relay flow path which is disposed between the first flow path and the second flow path and which connects the first flow path and the second flow path; and
a cylindrical space disposed on the solenoid side in the axial direction when viewed from the first flow path and having a wall which faces the solenoid on one side in the axial direction;
a valve body in a columnar shape disposed in the cylindrical space and movable along the axial direction together with the plunger, the valve body comprising:
a valve part which opens and closes the relay flow path on the one side in the axial direction; and
a guide part which contacts the plunger on the other side in the axial direction and is guided on an inner wall surface of the cylindrical space when moving together with the plunger; and
a spring which is disposed concentrically with the valve body on an outer peripheral side of the valve body in the cylindrical space, contacts the wall of the cylindrical space on the one side in the axial direction, contacts the guide part on the other side in the axial direction, and urges the valve body along the axial direction.

2. The electromagnetic valve according to claim 1, wherein an outer periphery of the valve body slides on the wall when the valve body moves in the axial direction.

3. The electromagnetic valve according to claim 2, wherein the valve body has an enlarged diameter part with an enlarged outer diameter at a portion that slides on the wall.

4. The electromagnetic valve according to claim 3, wherein the spring is a coil spring, and
an outer periphery of the enlarged diameter part contacts an inner periphery of the coil spring.

5. The electromagnetic valve according to claim 1, wherein the guide part has a plurality of protrusions provided to protrude from an outer periphery of the valve body toward an outer side in a radial direction.

6. The electromagnetic valve according to claim 2, wherein the guide part has a plurality of protrusions provided to protrude from the outer periphery of the valve body toward an outer side in a radial direction.

7. The electromagnetic valve according to claim 3, wherein the guide part has a plurality of protrusions provided to protrude from the outer periphery of the valve body toward an outer side in a radial direction.

8. The electromagnetic valve according to claim 4, wherein the guide part has a plurality of protrusions provided to protrude from the outer periphery of the valve body toward an outer side in a radial direction.

9. The electromagnetic valve according to claim 1, wherein the spring is configured to be able to move the plunger to the other side in the axial direction, and
the solenoid is configured to be able to move the plunger to the one side in the axial direction against an urging force of the spring.

10. The electromagnetic valve according to claim 2, wherein the spring is configured to be able to move the plunger to the other side in the axial direction, and
the solenoid is configured to be able to move the plunger to the one side in the axial direction against an urging force of the spring.

11. The electromagnetic valve according to claim 3, wherein the spring is configured to be able to move the plunger to the other side in the axial direction, and
the solenoid is configured to be able to move the plunger to the one side in the axial direction against an urging force of the spring.

12. The electromagnetic valve according to claim 4, wherein the spring is configured to be able to move the plunger to the other side in the axial direction, and
the solenoid is configured to be able to move the plunger to the one side in the axial direction against an urging force of the spring.

13. The electromagnetic valve according to claim 5, wherein the spring is configured to be able to move the plunger to the other side in the axial direction, and
the solenoid is configured to be able to move the plunger to the one side in the axial direction against an urging force of the spring.

14. The electromagnetic valve according to claim 1, wherein the spring is a coil spring.
